(19) United States
(12) Patent Application Publication
(10) Pub. No.: US 2024/0318473 A1
(43) Pub. Date: Sep. 26, 2024

(54) LOCK FOR A MOTOR VEHICLE

(71) Applicant: KIEKERT AG, Heiligenhaus (DE)

(72) Inventors: Ömer INAN, Dorsten (DE); Holger SCHIFFER, Meerbusch (DE); Michael SCHOLZ, Essen (DE); Peter SZEGENY, Engelskirchen (DE); Andreas ZIGANKI, Mettmann (DE); Andreas SCHMITZ, Velbert (DE)

(73) Assignee: KIEKERT AG, Heiligenhaus (DE)

(21) Appl. No.: 18/577,754

(22) PCT Filed: Jul. 20, 2022
(86) PCT No.: PCT/DE2022/100527

§ 371 Date: Jan. 9, 2024

(30) Foreign Application Priority Data
Jul. 28, 2021 (DE) 10 2021 119 652.3

(51) Int. Cl. E05B 77/34; E05B 81/04; E05B 85/02

(52) U.S. Cl. CPC E05B 77/34; E05B 81/04; E05B 85/02

(57) ABSTRACT

A lock for a motor vehicle, comprising a locking mechanism with a rotary latch and at least one pawl, a lock housing with at least one housing cover, a printed circuit board located in an interior of the lock housing, and an electronic component located on the printed circuit board. A membrane is located in the housing so that at least a pressure compensation through the membrane is possible.

The invention relates to a lock for a motor vehicle, comprising a locking mechanism with a rotary latch and at least one pawl, a lock housing with at least one housing cover, a printed circuit board located in an interior of the lock housing, and at least one electronic component located on the printed circuit board.

Locks for motor vehicles are used where parts movably mounted on the motor vehicle, such as doors, hinged closure elements, covers, and/or sliding doors, must be held or secured in their position. The locks have the primary task of securely holding the movable part in its position even during an extreme situation, and thus protecting the operator or user of the motor vehicle from injuries. Such locks are also used in regions which are subject to environmental influences and which can thus come into contact with moisture, dust, and/or other environmental influences.

In particular, the region of the locking mechanism comes into contact with moisture or can even be directly affected by wetness. In addition to the pure securing function of holding the movable part, the lock now faces more and more further tasks. In addition to the pure mechanical holding of the movable part, the lock can also contain electronics, which are particularly susceptible to moisture. The electronics can serve, for example, to control a motor located in the motor vehicle lock and to supply it with corresponding electrical power, or switching means can be contained in the motor vehicle lock, wherein, for example, positions of functional parts in the motor vehicle lock can be queried using the switching means.

DE 10 2009 027 415 A1 discloses a lock for a motor vehicle, said lock offering protection against external influences, such as dust, moisture, or manipulation. In this case, a lock has a lock housing and a housing cover for the lock housing, wherein a peripheral slit, via which moisture can penetrate into the lock, remains between the lock housing and the cover. In order to protect the parts of the lock in the interior, in this case wrapping an adhesive film around the lock multiple times at least in parts in order to reliably and lastingly protect the lock against external influences is proposed.

DE 10 2016 103 428 A1 discloses a motor vehicle locking device in which a printed circuit board is located in the interior, wherein the printed circuit board has electrotechnical components and an electronic illuminant. The printed circuit board is connected directly to an electrical component carrier, i.e., an element with at least electrical connecting lines.

In order to protect the printed circuit board and/or other electronic components in the motor vehicle lock from penetrating moisture, the motor vehicle lock can be divided into a dry region and a wet region. Such a lock is known, for example, from EP 2 754 799 A1. The printed circuit board and the other electronic components are located between a cover cap and a lock cover such that they are sealed off from moisture.

In addition to the influence of direct moisture, the motor vehicle lock is also subject to strong temperature fluctuations. Motor vehicle locks must cover temperature ranges from −40° C. to +80° C. in order to work properly in all climate zones. However, temperature influences can have an influence on the humidity, and—particularly in the event of strong temperature fluctuations—moisture can be released from the air, such that the electronic parts can be affected by moisture.

DE 102 59 465 A1 discloses an actuating drive, in which the movement of the actuating means results in pressure differences in the interior of the actuating drive. The actuating drive can likewise be arranged in the wet region of a motor vehicle, so that the internal parts, as well as the actuating means, must be tightly sealed. In order that these pressure differences can be compensated for and at the same time no moisture can get into the interior of the actuating drive, the document proposes providing a venting bore which is moisture-impermeable and at the same time air-permeable. For this purpose, a membrane is inserted into the venting bore; pressure compensation can occur through the membrane, but at the same time the membrane is made of a semi-permeable plastic material which prevents the ingress of moisture.

The invention addresses the technical problem of developing a motor vehicle lock of the type mentioned at the outset in such a way that no moisture the function of the printed circuit board like protects the electronic parts located on the printed circuit board from moisture.

According to the invention, the object is achieved by the features of independent claim 1. Advantageous embodiments are specified in the dependent claims. It should be noted, however, that the exemplary embodiments described below are not limiting; rather, any possible variations of the features described in the description, the claims, and the drawings are possible.

According to claim 1, the object of the invention is achieved in that a lock for a motor vehicle is provided, having a locking mechanism with a rotary latch and at least one pawl, a lock housing with at least one lock cover, a printed circuit board located in an interior of the lock housing, and at least one electronic component located on the printed circuit board, wherein a membrane is located in the housing so that at least a pressure compensation through the membrane is possible. The lock housing design according to the invention makes it possible to provide the internal space of the lock housing and in particular the region of the printed circuit board with pressure compensation, so that pressure compensation is enabled in the event of temperature fluctuations. Air circulation, which is present within certain limits, between the interior of the lock housing and the ambient air makes it possible to react to temperature fluctuations. If, due to large temperature fluctuations, the air in the interior of the motor vehicle lock heats up, pressure compensation through the membrane can take place. If, on the other hand, the air and the lock cool down, condensation of the humidity in the interior of the motor vehicle lock can be prevented by pressure compensation.

If reference is made to a lock for a motor vehicle in the sense of the invention, this includes all locking systems used to hold a movable part in the motor vehicle. These locking systems have a locking mechanism with a rotary latch and at least one pawl, wherein the rotary latch can be brought into engagement with a striker, and the pawl can hold the rotary latch in at least one ratchet position. Such a lock can be used, for example, in a side door, a hinged closure element, a hood, and/or a sliding door, to name only some examples of the use of the motor vehicle lock according to the invention.

If the motor vehicle lock is used, for example, in a side door, two ratchet positions are specified in the locking mechanism. When the side door is being closed, the locking mechanism passes first into a pre-ratchet position and, for complete closing, into a main ratchet position. The rotary latch can be secured in the ratchet position by means of a pawl or a pawl and a blocking or ratchet lever, depending upon whether a closing or opening torque occurs in the locking mechanism. The locking mechanism is mounted in the motor vehicle lock on a metal lock case and can additionally be secured in the axle receptacles by means of a reinforcement plate.

In order to protect the locking mechanism and the other functional parts contained in the motor vehicle lock from soiling and/or moisture, and to provide holding or bearing points for the functional parts of the lock, the lock has a lock housing with at least one housing cover. In addition to the housing cover, there can be a cover cap in the lock-particularly in the case in which there are weather-sensitive parts in the motor vehicle lock. This cover cap then has the task of forming a wet region and a dry region in the motor vehicle lock. As a result, there is the possibility of arranging the wetness- or moisture-sensitive parts separately in the motor vehicle lock and providing additional safety in the motor vehicle lock. Such moisture-sensitive parts are, for example, electronic components, a printed circuit board, or an electric motor. These parts located in the interior of the lock housing are particularly moisture-sensitive, since a moisture intrusion can impair the functionality of these parts.

The printed circuit board is advantageously located in a separate dry region of the motor vehicle lock. The dry region is characterized in that no moisture can penetrate directly into this region. The dry region can be formed by the lock housing in conjunction with the housing cover and with a shaping of the lock housing and/or of the lock cover, or can be formed by means of an additional cover cap in the lock. The printed circuit board is consequently located in an isolated and/or sealed dry region of the motor vehicle lock and is connected there to the control and/or power supply of the motor vehicle lock by means of an electrical component carrier and/or a connection plug. Arranging the printed circuit board in the dry region allows the printed circuit board and/or the electronic components to be reliably protected from penetrating moisture. However, in particular temperature fluctuations and the high temperature fluctuations between −40° C. and 80° C. occurring in the motor vehicle lead to the possibility of humidity being released from the air, so that moisture can in turn reach the region of the printed circuit board and/or of the electronic components. In addition to the large temperature differences, pressure differences play a decisive role in the formation of condensation in the motor vehicle lock. In order to compensate for these pressure differences, according to the invention, a membrane is located in the motor vehicle housing, so that pressure differences can be compensated for. Condensation formation can thus be prevented.

If the membrane is moisture-impermeable in the direction of the interior of the lock housing, additional security against condensation formation can be ensured. The membrane is moisture-impermeable, but allows pressure compensation, so that different pressures, e.g., due to strong temperature fluctuations, can be compensated for. The risk of condensation formation can thus be effectively prevented. In addition, moisture can escape from the lock through the membrane from the lock, but it can be ensured that no moisture penetrates into the motor vehicle lock.

The membrane can advantageously be located in the housing cover. The housing cover closes the lock housing and can be of a single-part or multi-part design. In particular, the housing cover can form at least part of the dry space and can be used for safe arrangement of the printed circuit board and/or electrical components. The arrangement of the membrane in the housing cover thus makes it possible to advantageously arrange the pressure compensation specifically in the region of the moisture-sensitive components. For this purpose, the housing cover can have a peripheral seal, which can be brought into engagement with the lock housing and can preferably form a dry space. However, seals can only be a means of preventing direct moisture access; complete sealing can be ensured only conditionally. Thus, moisture penetrating into the dry region can also influence the humidity in the dry region and, in conjunction with the temperature fluctuations, lead to condensation formation. By installing the membrane in the housing cover, pressure compensation can be ensured, and a means for removing the moisture by means of the air through the membrane can be provided.

The printed circuit board and/or the electronic or electrical components can be located in the dry space of the lock housing. The moisture-sensitive parts can thus be protected. In order to enable the interaction between the electrical, electronic, and/or mechanical parts in the dry region, seals can be provided which enable interaction of the parts located in the dry space with the parts located in the housing. The housing region also accommodates the locking mechanism, for example. The locking mechanism interacts with a striker, which is located, for example, on a B-pillar of the motor vehicle. This region of the locking mechanism is open and can come into direct contact with moisture and/or wetness. The moisture or wetness penetrating into the housing can also pass through the seals in the interior of the motor vehicle lock into the dry region, so that, in turn, an influence on the humidity in the dry space is enabled. Electrical connections, such as contact between a motor located in the dry region and an electrical component carrier or a conducting track, can also open up possibilities for moisture to penetrate into the dry region. Arranging the electrical or electronic parts and/or, for example, also an electrical component carrier in the dry space makes it possible to protect these components from direct intrusion of moisture, but complete isolation can be ensured only conditionally. By the use of the membrane, an additional means for safely arranging moisture-sensitive parts in the motor vehicle can be provided.

If the membrane is arranged in the lock housing and/or lock cover in such a way that pressure compensation in the dry space can be enabled, an advantageous design of the invention can be achieved. The pressure compensation is advantageous in particular in a sealed dry space, since released moisture can occur in the dry region due to the penetrating moisture described above and due to the temperature fluctuations to which the motor vehicle is subject. By introducing the membrane into the lock housing and/or the lock cover, however, in the dry space region, an effective means against condensation formation can be provided. If the membrane is preferably arranged in the lock cover, there is, however, also the possibility of arranging the membrane, for example, in the interior and for instance in a cover cap of the motor vehicle lock. The arrangement of the membrane in an electrical component carrier which delimits a dry space may also be conceivable according to the invention. In any case, pressure compensation is to be made possible in such a way that a positive pressure in the region of the moisture-sensitive parts of the motor vehicle lock is enabled.

If the membrane is made of a semi-permeable plastic material, and in particular semi-permeable and stretched polytetrafluoroethylene, an advantageous embodiment variant of the invention results. In this case, the membrane has a two-layer structure with a usually upper layer made of a semi-permeable plastic material composed of semi-permeable and stretched BTFE. This semi-permeable layer made of the plastic material in question is supported and held by a supporting layer made of a support material, likewise composed of plastic. Polyamide (PA) is usually used here, wherein the two layers are connectable to one another by means of an adhesive.

Advantageously, in another embodiment variant, the membrane is located directly in the region of the printed circuit board. The printed circuit board with the electrical and/or electronic parts located on the printed circuit board is a particularly protection-worthy part in the motor vehicle lock, since the electrical connections and also the parts themselves are moisture-sensitive and have to be protected over the long term. Locks or locking systems have lifetimes which can extend over decades, so that even slight penetrating moisture in the region of the printed circuit board can lead to malfunctions or failures in the motor vehicle lock. The arrangement of the membrane in the region of the printed circuit board thus forms a proven means for ensuring the safety and, in particular, the longevity of the motor vehicle lock.

According to the invention, two, three, or more membranes can be arranged in the motor vehicle lock or in the lock housing and/or lock cover. Depending upon the design and arrangement of the electrical or electronic parts, two or more membranes in the motor vehicle lock may be necessary in order to be able to ensure reliable pressure compensation. For example, two dry regions can also be arranged in the motor vehicle lock, so that two membranes can also be assigned to the dry regions. Of course, it is also conceivable that only one dry region be assigned two or more membranes, so that, in any case, air transport and moisture transport through the membrane can be enabled in order to reliably protect the dry region or the electrical and/or electronic parts in the motor vehicle lock.

As a result of the design, according to the invention, of the motor vehicle lock with an arrangement of a membrane in the lock housing and/or lock cover, the safety and, in particular, the longevity of the motor vehicle lock can be ensured.

In the following, the invention is explained in more detail with reference to the appended drawing using an embodiment. However, the principle applies that the embodiment does not limit the invention, but is merely an advantageous embodiment. The features shown can be implemented individually or in combination with further features of the description as well as the claims, individually or in combination.

In the figures:

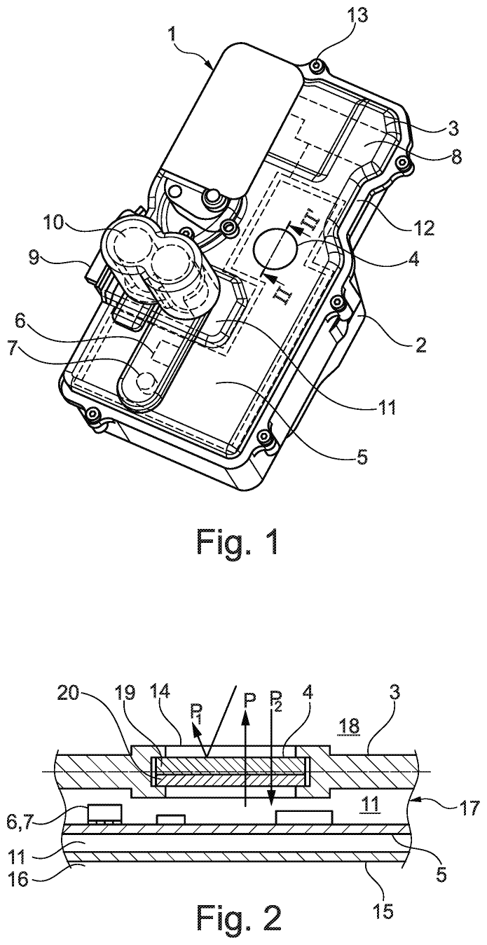

FIG. 1 shows a three-dimensional view of a motor vehicle lock designed according to the invention, with a membrane in the housing cover; and

FIG. 2 shows a section along the line II-II according to FIG. 1 through the membrane fastened in the housing cover.

FIG. 1 shows a lock 1 in a three-dimensional view. The lock housing 2 and a housing cover 3 mounted on the lock housing can be seen. A membrane 4 in pressure compensation in the motor vehicle lock 1 is located in the housing cover 3.

In FIG. 1, the housing cover 3 is shown transparent so that the printed circuit board 5 located below the housing cover 3 can be seen. Electronic components 6, 7 are fastened on the printed circuit board 5, and an electric motor 8 is electrically connected to the printed circuit board 5. Collectively, the electrical circuitry or electronics 5, 6, 7, 8 in the motor vehicle lock 1 are connected to the on-board electronics of the motor vehicle by means of a plug 9 on the housing 2. Additional capacitive parts 10 are likewise located under the housing cover 3. Below the housing cover 3, there is a dry space 11 in which the printed circuit board and the electronic or electrical components 5, 6, 7, 8, 10 are located. The membrane 4 is located directly above the printed circuit board 5 in the housing cover 3, so that the dry space 11 can be vented and thus dehumidified via the membrane 4.

In principle, a seal is located peripherally at the edge 12 of the motor vehicle lock 1, and the housing cover is fastened to the lock housing 2 by means of screws 13.

FIG. 2 shows a section through the housing cover 3 in the region of the membrane 4 along the line II-II from FIG. 1. The membrane 4 is held in an opening 4 of the housing cover 3 and located directly above the printed circuit board 5. The printed circuit board 5 is located in the dry region 11 of the motor vehicle lock 1. The dry space 11 can be delimited by a cover cap 15, so that the dry region 11 can be separated from the wet region 16 by means of the cover cap 15.

The membrane 4 is accommodated and sealingly held in an opening 14 of the lock housing cover 3. If, as a result of temperature fluctuations and/or leaks, air present in the dry region 11 is heated, the pressure can be compensated for through the membrane 4 in the direction of the arrow P. For this purpose, the membrane 4 is air-permeable in the direction of the arrow P, but moisture-impermeable. Moisture incident on the membrane 4, which moisture is symbolized by the arrow P1, is pushed back or blocked by the membrane 4, so that no moisture can penetrate through the membrane. However, an air exchange between the internal space 17 of the lock 1 can travel outwards into the environment 18. Any moisture occurring in the interior 17 of the motor vehicle lock 1 can thus be compensated for through the membrane 4 as part of an air circulation through the membrane 4. For this purpose, the membrane 4 is air-permeable in the direction of the arrow P2.

The membrane 4 itself is constructed in two layers, wherein a semi-permeable plastic layer 19 is located on the upper side, i.e., on the environment side 18, wherein the plastic layer 19 is supported and held on a support material 20.

As a result of the design, according to the invention, of the motor vehicle lock with a membrane for pressure compensation, condensation formation in the interior 17 and in particular in a dry space 11 can, advantageously, be prevented. In particular, the longevity of electronic locks is thereby improved.

### LIST OF REFERENCE SIGNS

1 lock
2 lock housing
3 housing cover
4 membrane
5 printed circuit board
6, 7 electronic components
8 electric motor
9 plug
10 capacitive parts
11 dry space
12 edge
13 screws
14 opening
15 cover cap
16 wet region
17 Internal space
18 environment
19 plastic material
20 support material
P, P1, P2 arrow

1. A lock for a motor vehicle, comprising:
a locking mechanism with a rotary latch and at least one pawl,
a lock housing with at least one housing cover,
a printed circuit board located in an interior of the lock housing,
at least one electronic component located on the printed circuit board, and
a membrane located in the housing so that a pressure compensation through the membrane is performed,
wherein the printed circuit board is located in a dry space of the lock housing, wherein at least part of the dry space is formed by the housing cover,
wherein the printed circuit board and the at least one electronic components are located below the housing cover,
wherein the at least one electronic component is fastened on the printed circuit board and the printed circuit board is configured for electrical connection to an electric motor,
wherein the printed circuit board and/or the at least one electronic component are configured to be connected to on-board electronics of the motor vehicle by a plug on the housing,
wherein additional capacitive parts are located under the housing cover, and
wherein the membrane is located directly above the printed circuit board in the housing cover so that the dry space is vented and dehumidified via the membrane.

2. The lock according to claim 1, wherein the membrane is moisture-impermeable across the membrane in a direction toward the interior of the lock housing.

3. The lock according to claim 1, wherein the membrane is located in the lock housing such that pressure compensation in the dry space is performed.

4. The lock according to claim 1, wherein the membrane is made of a semi-permeable plastic material.

5. The lock according to claim 1, wherein two or four membranes are located in the motor vehicle lock.

6. The lock according to claim 4, wherein the semi-permeable plastic material is a semi-permeable and direct polytetrafluoroethylene.

7. The lock according to claim 4, wherein the semi-permeable plastic material has a two-layer structure including an upper layer that is supported by a lower supporting layer.

8. The lock according to claim 7, wherein the upper layer is made of semi-permeable and stretched BTFE material, and the lower supporting layer is made of polyamide.

9. The lock according to claim 1, wherein the at least one cover includes a cover cap that separates the dry space from a wet space of the lock housing.

10. The lock according to claim 2, wherein the membrane is moisture-permeable across the membrane in a direction away from the interior of the lock housing.

11. The lock according to claim 1, wherein the housing cover includes a peripheral seal that is brought into engagement with the lock housing to form the dry space.
